(19) United States
(12) Patent Application Publication
(10) Pub. No.: US 2008/0011181 A1
(43) Pub. Date: Jan. 17, 2008

(54) Cableway system having at least one conveying cable

(75) Inventors: Gunter Troy, Wolfurt (AT); Gerd Dur, Bildstein (AT)

Correspondence Address: LERNER GREENBERG STEMER LLP, P O BOX 2480, HOLLYWOOD, FL, 33022-2480, US

(73) Assignee: Innova Patent GmbH

(21) Appl. No.: 11/801,975

(22) Filed: May 11, 2007

(30) Foreign Application Priority Data
Jul. 13, 2006 (AT) A 1195/2006
Feb. 12, 2007 (AT) A 221/2007

(51) Int. Cl. B61B 3/00; G06F 7/00

(52) U.S. Cl. 104/96; 701/19

(57) ABSTRACT

A cableway system has at least one continuous conveying cable, which is guided over deflecting pulleys in the terminal stations, and transport devices, such as cablecars and chairs, that can be coupled to the conveying cable. Guide rails are provided in the stations along which the transporting means uncoupled from the conveying cable can be displaced. Two vertical conveying wheels rotatably supported about a horizontal axis are provided in at least one of the stations for moving the transport devices between an upper plane and a lower plane in the station. The transport devices are uncoupled from the conveying cable, guided along a first guide rail in the upper plane of the station to a first vertical conveying wheel, which moves them from the upper plane into the lower plane, moved along the second guide rail in the lower plane through a passenger boarding and disembarking region, and moved to the second vertical conveying wheel, which conveys them back into the upper plane. There, they are guided along the third guide rail to the conveying cable and coupled thereto.

### CROSS-REFERENCE TO RELATED APPLICATIONS

This application claims the priority, under 35 U.S.C. §119, of Austrian patent application A 1195/2006, filed Jul. 13, 2006, and Austrian application A 221/2007, filed Feb. 12, 2007; the prior applications are herewith Incorporated by reference in their entirety.

### BACKGROUND OF THE INVENTION

1. Field of the Invention

The present invention relates to a cableway system having at least one conveying cable, which is guided over deflecting pulleys in the stations, having transporting means, such as cablecars and chairs, which can be coupled to the conveying cable and are designed with running-gear mechanisms, and having guide rails, which are provided in the stations and along which the transporting means uncoupled from the conveying cable can be moved through the boarding and disembarking region for the passengers in the stations.

In the case of known cableway systems with station buildings and with cablecars that can be coupled to a supporting and conveying cable and/or to a haulage cable, the boarding and disembarking region for the passengers is usually located in a plane situated above the terrain surrounding the station building. The reason for this is that this means that the terrain surrounding the station buildings is not required for the operation of the cableway systems, wherein case this terrain is available as a means of access for the passengers, as a road surface, as a parking area and the like. The station buildings are thus of two-story design, the lower story containing an entrance hall, installation or assembly areas and the like, and the upper story containing the boarding and disembarking region for the passengers.

This spatial arrangement, means that the passengers have to negotiate steps, elevators or ramps in order to reach the boarding and disembarking regions of the cableway systems. Where cableway systems designed with chairs for passengers with skis attached are concerned, dedicated access ramps would have to be set up for the skiers.

### SUMMARY OF THE INVENTION

It is accordingly an object of the invention to provide a cableway system which overcomes the above-mentioned disadvantages of the heretofore-known devices and methods of this general type and wherein at least one of the stations is designed such that the boarding and disembarking region is located more or less in the plane of the terrain surrounding the station building, with the result that the boarding and disembarking region is accessible to all passengers without steps, elevators, ramps and the like having to be negotiated and, irrespective of this, all the terrain surrounding the station building can be utilized as required.

With the foregoing and other objects in view there is provided, in accordance with the invention, a cableway system, comprising:
terminal stations (e.g., valley station, mountain station) having deflecting pulleys disposed therein;
at least one continuous conveying cable guided over the deflecting pulleys in the valley station and in the mountain station;
transport devices formed with running-gear mechanisms and configured for coupling to the conveying cable;
first and second vertical conveying wheels rotatably supported about substantially horizontal axes in at least one of the stations, for moving the transport devices between an upper plane in the station and a lower plane in the station;
guide rails disposed in the stations for guiding the transport devices while the transport devices are uncoupled from the conveying cable, the guide rails including a first guide rail, a second guide rail, and a third guide rail;
wherein the guide rails and the vertical conveying wheels are configured such that the transport devices, uncoupled from the conveying cable, are guided along a first guide rail in the upper plane of the station, to the first vertical conveying wheel, moved from the upper plane into the lower plane, guided along a second guide rail in the lower plane of the station, through a passenger boarding and disembarking region and to the second vertical conveying wheel, moved from the lower plane back to the upper plane, guided along a third guide rail to the conveying cable, and coupled to the conveying cable.

In other words, the objects are achieved according to the invention in that in at least one of the stations there are provided two vertical conveying wheels which can be rotated about at least more or less horizontally oriented axles and by way of which the transporting means can be moved between an upper plane located in the station and a lower plane located in the station, and in that, in the upper plane and in the lower plane, the guide rails follow the vertical conveying wheels, it being the case that the transporting means uncoupled from the conveying cable are fed along a first guide rail, in the upper plane of the station, to a first vertical conveying wheel, which moves them from the upper plane into the lower plane, whereupon they are moved along a second guide rail, provided in the lower plane, through the boarding and disembarking region for the passengers and moved to the second vertical conveying wheel, which conveys them back into the upper plane, wherein they are moved along a third guide rail to the conveying cable and are then coupled thereto.

The conveying cable, which is continuous, is preferably designed with in each case one pair of strands which move in the same directions and to which the transporting means can be coupled by way of at least one pair of clamping jaws.

Furthermore, the two vertical conveying wheels are formed by in each case two wheels which are spaced apart from one another by a spacing which is more or less equal to the spacing between the respectively two associated strands of the conveying cable. It is possible here, in the stations, for the outer strand and the inner strand of a first pair of the conveying cable to be guided over at least one deflecting wheel and to merge into the respective outer strand and inner strand of the second pair of the conveying cable. Some of the deflecting wheels, which are oriented at least more or less vertically, are preferably loaded by a counterweight.

According to a further-preferred embodiment, the at least more or less vertically oriented vertical conveying wheels are designed with supporting bars into which the clamps of the transport devices, hereinafter also referred to as transporting means, can be inserted and which can be rotated in relation to the vertical conveying wheels during rotation of the latter for the purpose of moving the transporting means between the upper and lower planes. Furthermore, the movement path of the transporting means in the lower plane of the station, as seen in plan view, is preferably located between the region where the transporting means is uncoupled from and/or coupled to, the conveying cable and the two vertical conveying wheels. In addition, the two vertical conveying wheels may be assigned groups of drive rollers.

According to a preferred method of operating a cableway system according to the invention, the transporting means, in particular cablecars, uncoupled from the conveying cable in a station are moved along a first guide rail to a first vertical conveying wheel, which moves them from an upper plane of the station into a lower plane of the station, whereupon the transporting means are moved along a second guide rail, in the lower plane, through the boarding and disembarking region for the passengers and are then moved to a second vertical conveying wheel, which moves them back into the upper plane, wherein they are moved along a third guide rail to the conveying cable and are then coupled thereto.

The front end of the second guide rail can preferably be pivoted by means of an actuating device.

Other features which are considered as characteristic for the invention are set forth in the appended claims.

Although the invention is illustrated and described herein as embodied in a cableway system having at least one conveying cable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a side view and section of a station of a cableway system according to the invention with the two vertical conveying wheels, the view taken along the line I-I in FIG. 1A;

FIG. 1A is a plan view onto the station according to FIG. 1;

FIG. 2 shows the cable routing in this station, as seen in the direction of the arrow A from FIG. 1A;

FIGS. 3, 3A and 3B show, on an enlarged scale in relation to FIG. 1, a side view of one of the vertical conveying wheels, in three different operating positions;

FIGS. 4 and 4A show details of the vertical conveying wheel according to FIGS. 3, 3A and 3B, and

FIGS. 5 and 5A show an end view of the vertical conveying wheel according to FIGS. 3, 3A and 3B with a cablecar borne thereby, in two operating positions.

### DESCRIPTION OF THE PREFERRED EMBODIMENTS

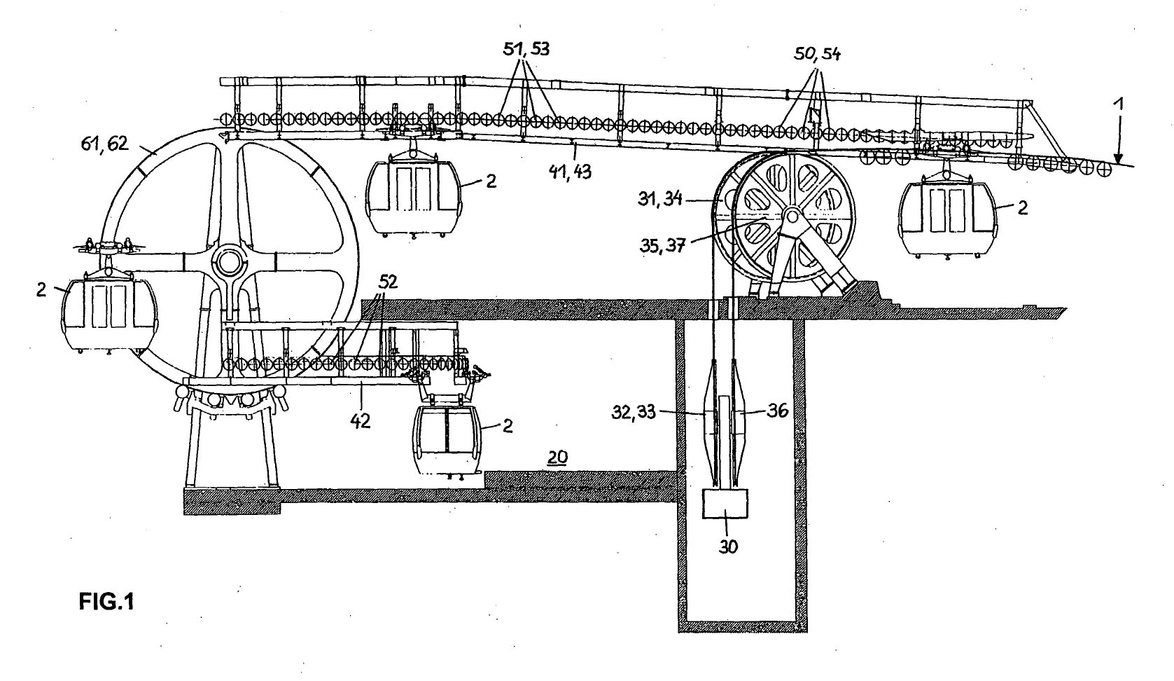

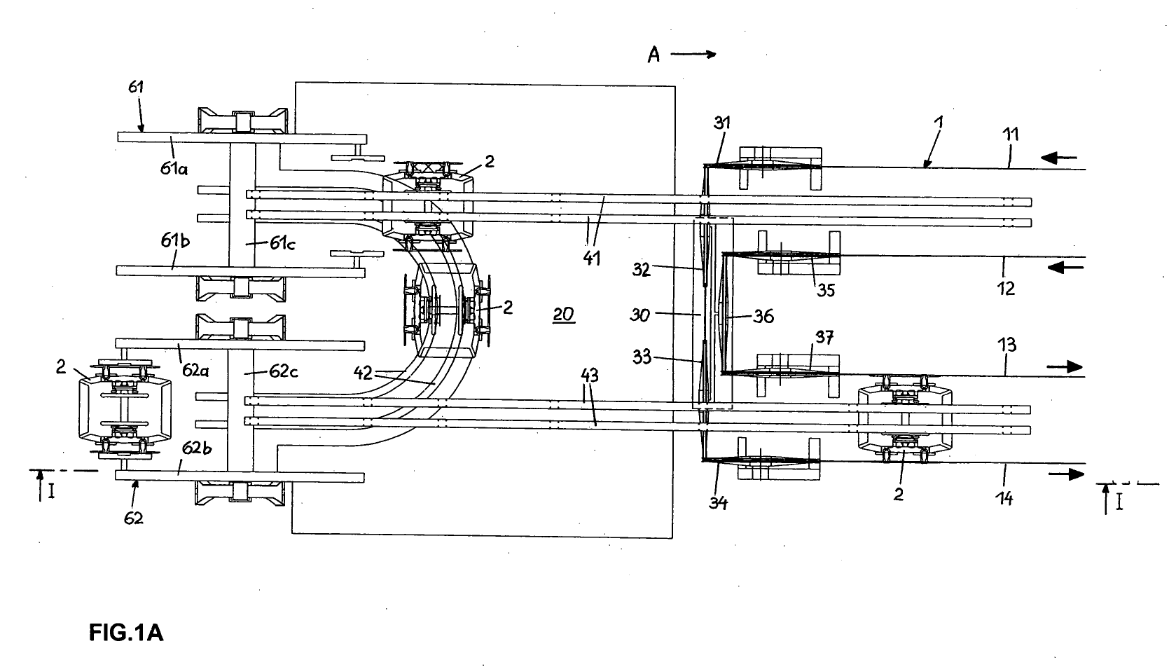

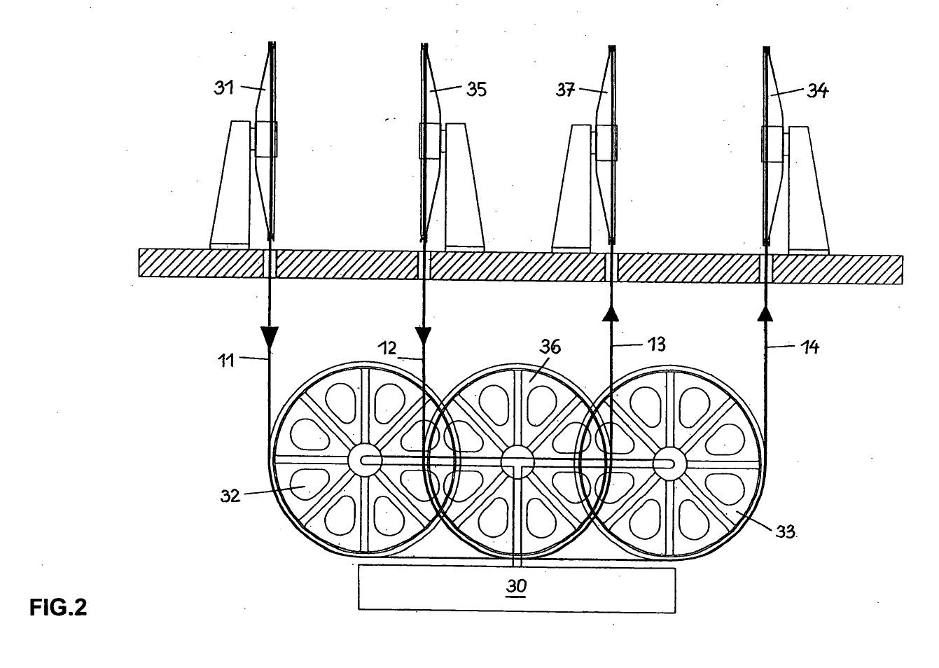

Referring now to the figures of the drawing in detail and first, particularly, to FIGS. 1, 1A, and 2 thereof, there is shown a terminal station, such as a valley station or a mountain station, of a cableway system which has a continuous supporting and conveying cable 1 for conveying cablecars 2, also referred to as gondolas, between the valley station and the mountain station. The supporting and conveying cable 1 is configured with two pairs of strands 11 and 12, 13 and 14 which move in the same directions in each case. The individual cablecars 2 can be coupled to the strand pairs 11 and 12, and 13 and 14, respectively, of the supporting and conveying cable 1 by means of at least one pair of clamps. These strands move in the same direction. Furthermore, the cablecars 2 are formed with running-gear mechanisms.

In the station, the strand 11 of the supporting and conveying cable 1 is guided away downward over a vertically oriented first deflecting pulley 31 and is guided over two further vertically oriented deflecting pulleys 32 and 33. The pulleys 32 and 33 are rotatably supported about axes that are oriented transversely to the axis of the first deflecting pulley 31. Thereupon, the strand 11 is guided over a fourth deflecting pulley 34, arranged parallel to the first deflecting pulley 31, and then merges into the strand 14. The strand 12 is guided likewise vertically downward over a fifth deflecting pulley 35, subsequently over a sixth deflecting pulley 36 and then over a seventh deflecting pulley 37, oriented parallel to the fifth deflecting pulley 35, whereupon it merges into the strand 13. The group of deflecting pulleys 32, 33 and 36 is designed with a counterweight 30, by way of which the supporting and conveying cable 1 is tensioned.

The station is configured with an upper plane (i.e., second story) and with a lower plane (i.e., first story). In the upper plane of the station, the two strands 11 and 12 of the supporting and conveying cable 1 are continued by two supporting bars of a first guide rail 41, which is assigned groups of decelerating wheels 50 and conveying wheels 51 which move the cablecars along the first guide rail 41, in the upper plane of the station, to a first vertical conveying wheel 61, which is located at that end of the station opposite from the entrance to the station. This vertical conveying wheel 61, also referred to as a heightwise conveying wheel 61, moves the cablecars 2 from the upper plane, wherein they are moved into the station, into the lower plane, where the passengers board or disembark. In the lower plane of the station, the vertical conveying wheel 61 is followed by a second guide rail 42, which is formed by two supporting bars and has associated conveying wheels 52 which move the cablecars 2 through the boarding and disembarking region 20 for the passengers. The cablecars 2 are then moved along the second guide rail 42 to a second vertical conveying wheel 62, which raises them once again into the upper plane of the cableway station. In this station, the second vertical conveying wheel 62 is followed by a third guide rail 43, which has two supporting bars and is assigned further conveying wheels 53 and then accelerating wheels 54. At the exit from the cableway station, the third guide rail 43 is assigned the cable strands 13 and 14 of the supporting and conveying cable 1.

As can also be seen from FIG. 1A, the two vertical conveying wheels 61 and 62 are formed by in each case two spaced-apart wheels 61a, 61b and 62a, 62b, which are connected rigidly to one another via axles 61c and 62c, respectively.

FIG. 2 shows the routing of the cable strands 11 and 12, 13 and 14 over the deflecting pulleys 31 to 37. The routing which the conveying cable 1 follows by way of these deflecting pulleys causes the strands 11 and 12, on the one hand, and the strands 13 and 14, on the other hand, to move in the same direction in each case, namely into the station and out of the station, as a result of which these pairs of strands convey the cablecars 2 clamped to them from a first station to a second station.

At the entrance to a station, the cablecars 2 are uncoupled from the supporting and conveying cable 1 and moved, by means of the decelerating wheels 50 and the conveying wheels 51, along the first guide rail 41 to the first vertical conveying wheel 61, which is rotated in the counterclockwise direction. The cablecars 2 are then moved, by means of the first vertical conveying wheel 61, into the lower plane, wherein they are moved along the second guide rail 42, by means of the conveying wheels 52, through the boarding and disembarking region 20 for the passengers. The cablecars 2 then reach the second vertical conveying wheel 62, which is rotated in the clockwise direction and by way of which the cablecars 2 are conveyed upward from the lower plane into the upper plane. In the upper plane, the cablecars 2 are moved along the third guide rail 43, by means of the conveying wheels 53, back to the supporting and conveying cable 1 again. The accelerating wheels 54 bring the cablecars 2 to the speed of the supporting and conveying cable 1, whereupon they are coupled to the strands 13 and 14 of the conveying cable 1.

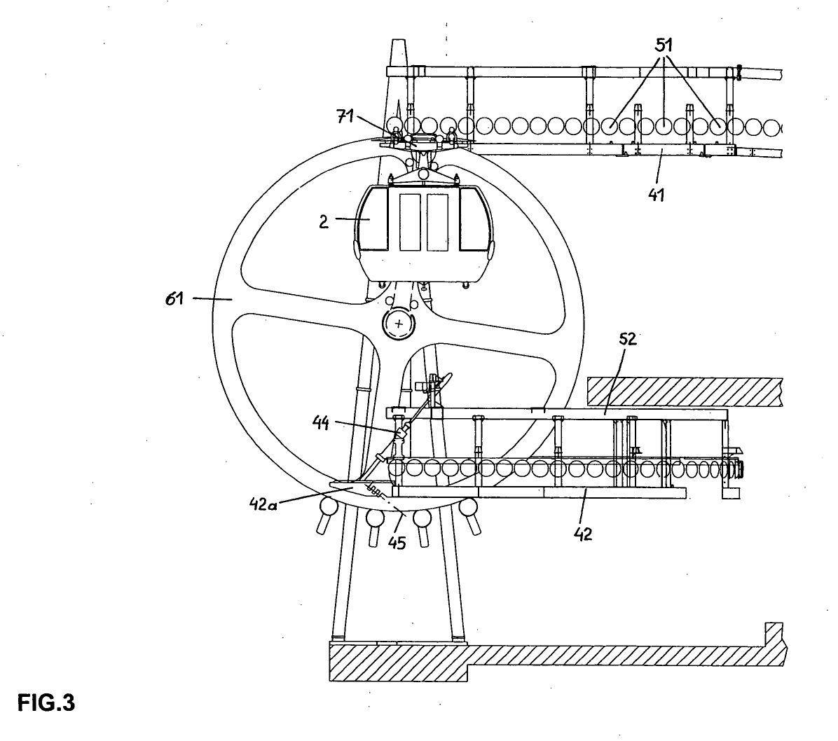

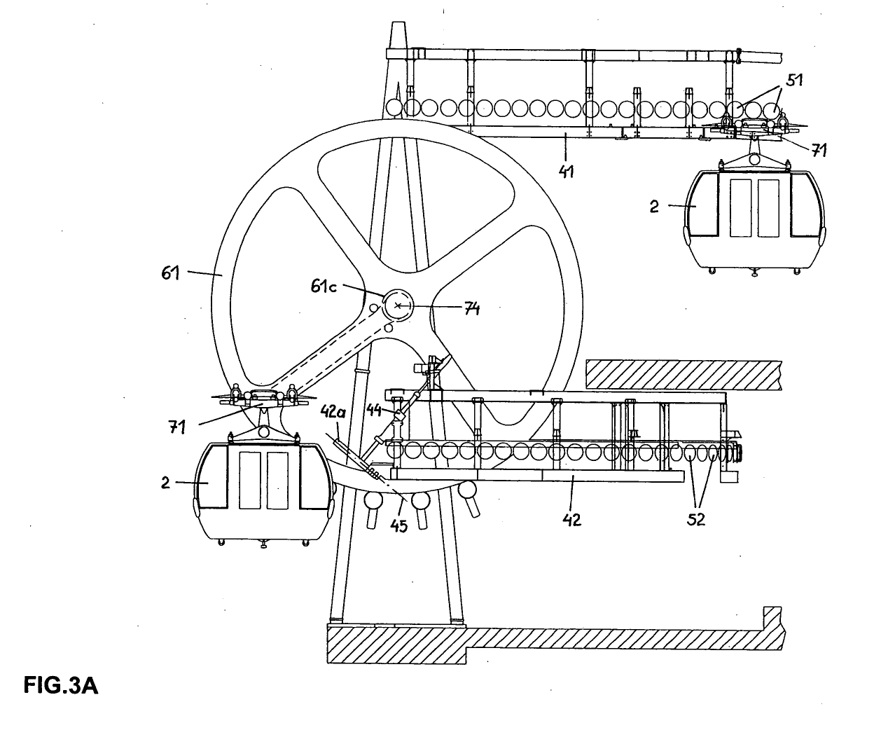

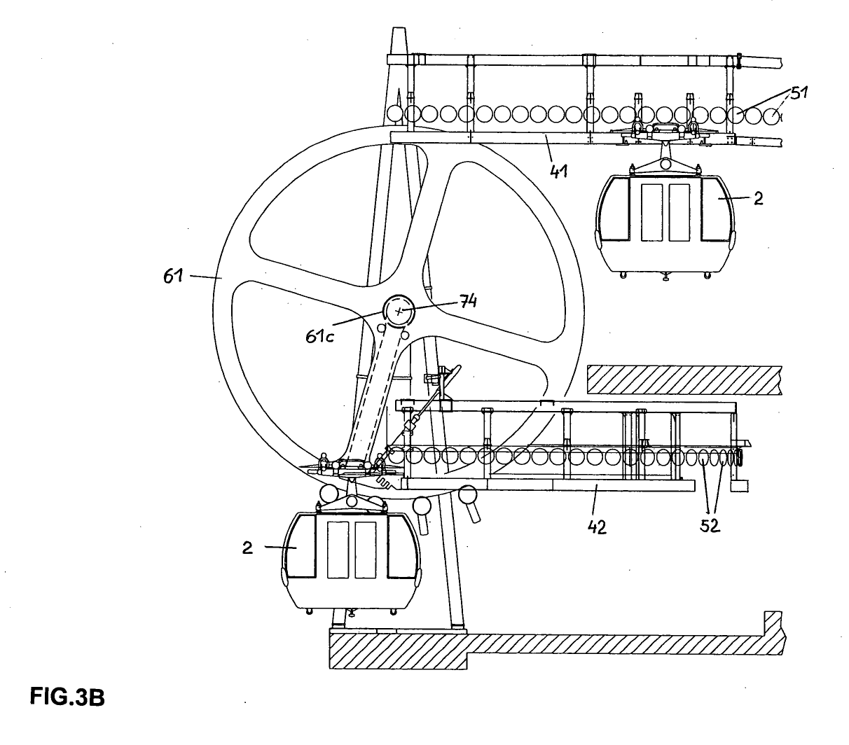

FIG. 3 shows the operating position wherein a cablecar 2 moved along the first guide rail 41 is received by the first vertical conveying wheel 61. As a cablecar 2 is received, a supporting bar 71 located on the vertical conveying wheel 61 runs into the open cable clamps of this cablecar 2 from beneath, as a result of which the cablecar 2 is lifted out of the first guide rail 41 by means of the first vertical conveying wheel 61. As can also be seen from FIG. 3, the front ends 42a of the two supporting bars of the guide rail 42 can be pivoted upward, and with respect to one another, along an obliquely running axis 45 in relation to this guide rail by means of an actuating device 44.

As soon as, as is illustrated in FIG. 3A, the cablecar 2 located on the first vertical conveying wheel 61 approaches the guide rail 42, the front ends 42a of the guide rail 42 are pivoted upward, wherein case the cablecar 2 moves past the same. The front ends 42a of the guide rail 42 are then adjusted back again into the plane of the guide rail 42.

As soon as the cablecar 2 has reached the lower plane, as is illustrated in FIG. 3B, the running-gear mechanisms of the cablecar 2 pass onto the second guide rail 42, along which the cablecar 2 is moved through the boarding and disembarking region 20 for the passengers.

A cablecar is received from the second guide rail 42 by the second vertical conveying wheel 62, and the cablecar 2 is transferred to the third guide rail 43, in an analogous manner.

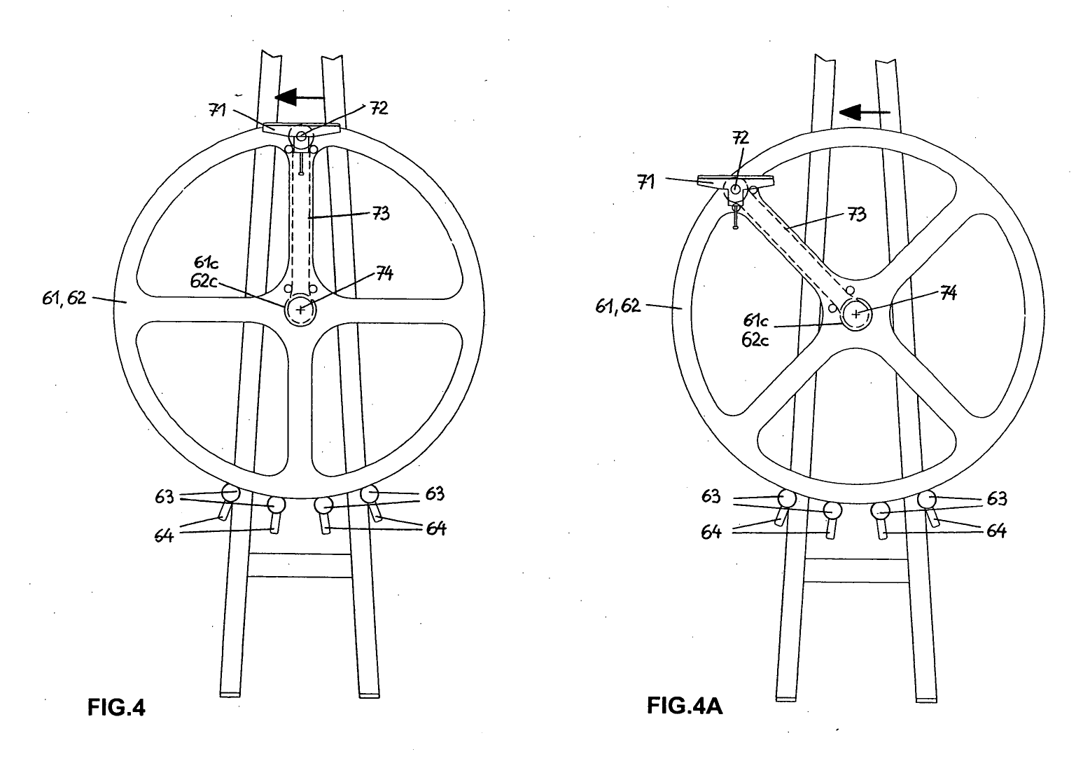

As can be seen from FIGS. 4 and 4A, the supporting bars 71 are mounted on the vertical conveying wheels 61, 62 such that they can be rotated about a horizontal spindle 72, and they are assigned at least one drive chain 73 positioned over a fixed bearing sleeve 74 of the vertical conveying wheels 61, 62. Rotation of the vertical conveying wheels 61, 62 thus rotate the shaft 72 such that the supporting bars 71 always remain in the horizontal position. This ensures that the cablecars 2 borne by the vertical conveying wheels 61, 62 always remain in the vertically oriented position irrespective of the rotary position of the vertical conveying wheels 61, 62.

These illustrations also show that the vertical conveying wheels 61, 62 are assigned four drive rollers 63 designed with drive motors 64.

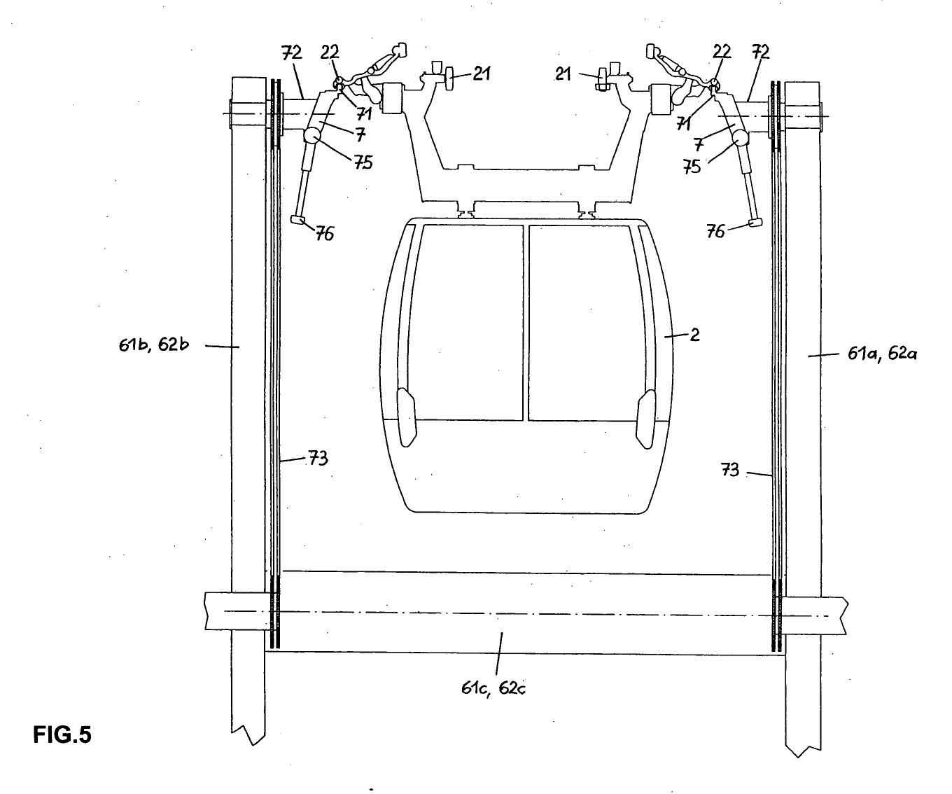

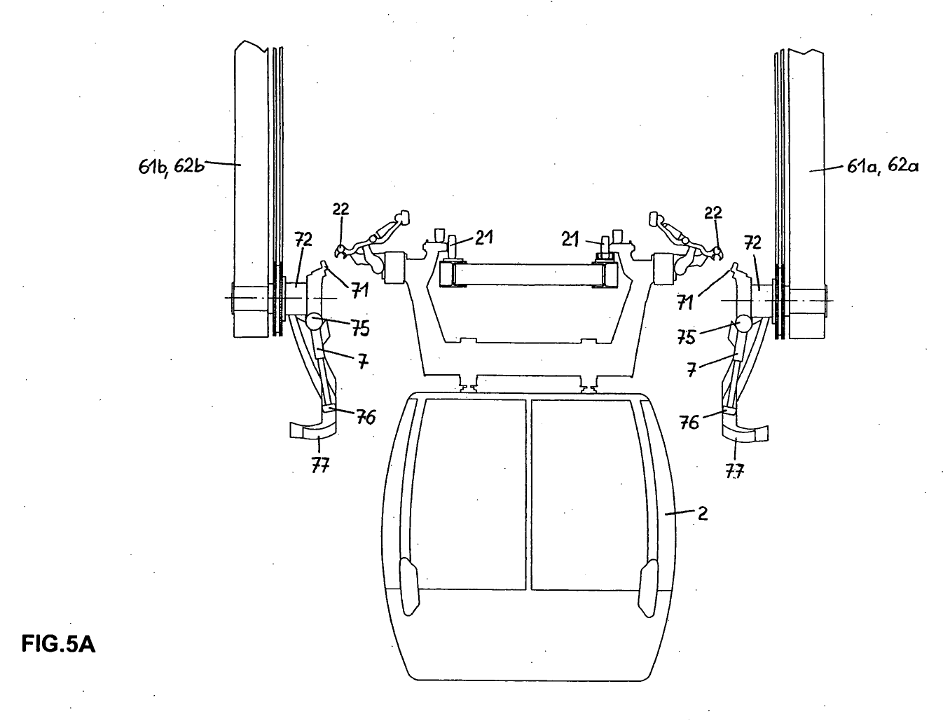

FIGS. 5 and 5A, furthermore, show the running-gear mechanisms 21 and the clamping jaws 22 of the cablecars 2. It can also be seen that a supporting lever 7 is mounted on each shaft 72 about a spindle 75 which is oriented transversely to the shaft 72, the supporting bars 71 being located at the top end of the supporting lever 7 and a control roller 76 being provided at the bottom end of the same. Furthermore, in the region of the lower plane of the cableway station, the control rollers 76 are each assigned a control rail 77.

If the actuating levers 7 have not been activated by the control rails 77, they are located in the position which can be seen from FIG. 5 and wherein the supporting bars 71 have been pivoted with respect to one another and are spaced apart from one another by the spacing of the clamping jaws 22. This allows the supporting bars 71 to move into the open clamping jaws 22, and out of the same, from beneath, as a result of which the cablecars 2 can be lifted off from the guide rails 41, 42 and 43, and set down thereon, by way of the vertical conveying wheels 61 and 62. In order nevertheless to prevent the supporting levers 7 from colliding with the cablecars 2 in the lower plane of the cableway station, they are pivoted apart from one another, as can be seen from FIG. 5A, by means of the control rails 77.

Such vertical conveying wheels can be used both for a cableway system which is provided with a supporting and conveying cable for the transporting means and for a cableway system wherein fixed supporting cables and moveable haulage cables are provided for conveying the transporting means. A conveying cable according to the patent claims is to be understood as being either a supporting and conveying cable or a haulage cable.

The transport devices, here illustrated as cablecars or gondolas 2, which are moved en route at a speed of approximately 6 m/sec, are moved at a speed of approximately 0.3 m/sec in the station and, in particular, in the boarding and disembarking region.

Since the transport devices are conveyed in opposite directions, both in the upper plane of the station and in the lower plane of the station, between the entrance region to the station, and/or the exit region from the station, and the vertical conveying wheels, the system is of very space-saving construction.

1. A cableway system, comprising:
terminal stations having deflecting pulleys disposed therein;
at least one continuous conveying cable guided over said deflecting pulleys in the valley station and in the mountain station;
transport devices formed with running-gear mechanisms and configured for coupling to said conveying cable;
first and second vertical conveying wheels rotatably supported about substantially horizontal axes in at least one of said stations, for moving said transport devices between an upper plane in said station and a lower plane in said station;
guide rails disposed in said stations for guiding said transport devices while said transport devices are uncoupled from said conveying cable, said guide rails including a first guide rail, a second guide rail, and a third guide rail;
wherein said guide rails and said vertical conveying wheels are configured such that said transport devices, uncoupled from said conveying cable, are guided along a first guide rail in the upper plane of the station, to said first vertical conveying wheel, moved from the upper plane into the lower plane, guided along a second guide rail in the lower plane of the station, through a passenger boarding and disembarking region and to said second vertical conveying wheel, moved from the lower plane back to the upper plane, guided along a third guide rail to said conveying cable, and coupled to said conveying cable.

2. The cableway system according to claim 1, wherein said continuous conveying cable is formed with a pair of strands moving in the same direction and being disposed for said transport devices to be coupled thereto by way of at least one pair of clamping jaws.

3. The cableway system according to claim 2, wherein each of said two vertical conveying wheels is formed by two wheels spaced apart from one another by a spacing substantially corresponding to a spacing between said strands of said pair of strands of said conveying cable.

4. The cableway system according to claim 2, wherein each pair of strands includes an outer strand and an inner strand and, in said stations, said inner and outer strands of a first pair of strands are guided over at least one deflecting wheel and merge into said inner and outer strands, respectively, of a second pair of strands.

5. The cableway system according to claim 4, wherein some of said deflecting wheels are oriented substantially vertically and are tensioned by counterweights.

6. The cableway system according to claim 1, wherein said vertical conveying wheels are oriented substantially vertically and are configured with supporting bars for inserting said transport devices, and wherein said supporting bars are rotatably supported in relation to said vertical conveying wheels during rotation thereof for moving said transport devices between the upper and lower planes.

7. The cableway system according to claim 1, wherein said station has a movement path for said transport devices defined in the lower plane which, in a plan view, is disposed between a location in which said transport devices are uncoupled from and/or coupled to said conveying cable and said two vertical conveying wheels.

8. The cableway system according to claim 1, which comprises groups of drive rollers associated with said two vertical conveying wheels and disposed to lead into an out of said vertical conveying wheels.

9. The cableway system according to claim 1, wherein said second guide rail has a front end pivotally disposed by way of an actuating device.

10. A method of operating the cableway system according to claim 1, which comprises:
uncoupling a transport device from the conveying cable in a station;
moving the transport device in the station along the first guide rail to a first vertical conveying wheel;
moving the transport device from an upper plane of the station into a lower plane of the station, and thereupon moving the transport device in the lower plane along the second guide rail, through a boarding and disembarking region for passengers, and to a second vertical conveying wheel;
moving the transport device from the lower plane to the upper plane of the station with the second vertical conveying wheel;
moving the transport device along a third guide rail to the conveying cable, and coupling the transport device to the conveying cable.
